(19) United States
(12) Patent Application Publication
(10) Pub. No.: US 2003/0135583 A1
(43) Pub. Date: Jul. 17, 2003

(54) Dynamic casting of objects while transporting

(76) Inventors: Peter A. Yared, San Francisco, CA (US); Bruce K. Daniels, Capitola, CA (US); Robert N. Goldberg, Emerald Hills, CA (US); Yury Kamen, Foster City, CA (US); Syed M. Ali, Sunnyvale, CA (US)

Correspondence Address: ROSENTHAL & OSHA L.L.P. / SUN, 1221 MCKINNEY, SUITE 2800, HOUSTON, TX, 77010, US

(21) Appl. No.: 10/046,117

(22) Filed: Jan. 11, 2002

(51) Int. Cl. G06F 15/16

(52) U.S. Cl. 709/218

(57) ABSTRACT

A method for dynamically casting an object graph, including creating an internal representation using a root object of the object graph, instantiating a cast object graph using a casting rule and the internal representation, and populating the cast object graph.

### BACKGROUND OF INVENTION

An “object graph” is a collection of related objects which are represented in forms including binary, text, XML (“Extensible Markup Language”), etc. FIG. 1 illustrates a class diagram. The class diagram 3 represents the classes that may be present in a given object graph, attributes associated with the classes, the relationships between the classes, and associated accessors. Further, the class diagram 3 encapsulates the class definitions necessary to create the class. For example, the class diagram in FIG. 1 contains a Purchase_Order class 2 with a PURCHASE_ORDER_ID attribute. The Purchase_Order class 2 is related to a LineItem class 4 with a one-to-many relationship. Further, the Purchase_Order class 2 contains an accessor, LineItems, for the relationship to the LineItem class 4. The LineItem class 4 contains a LINEITEM_ID attribute, a QUANTITY attribute, and a DISCOUNT attribute. Further, the LineItem class 4 contains an accessor, Product, for the relationship to the Product class 6, and an accessor, Purchase_Order, for the relationship to the Purchase_Order class 2. The LineItem class 4 is related to a Product class 6 with a one-to-one relationship. The Product class 6 contains a PRODUCT_ID attribute, a NAME attribute, and a PRICE attribute.

The class diagram 3, illustrated in FIG. 1, may be used to create numerous object graphs that conform to the class diagram. For example, FIG. 2 illustrates an exemplary object graph 8 that conforms to the class diagram (3 in FIG. 1). The object graph 8 contains a Purchase_Order_Object_{—}1 10 that contains a PURCHASE_ORDER_ID attribute. The Purchase_Order_Object_{—}1 10 is related to three LineItem objects 11, 12, and 13. As specified by the class diagram 3, each LineItem object 11, 12, and 13 contains a LINEITEM_ID attribute, a NAME attribute and a PRICE attribute. Each LineItem object 11, 12, 13 is related to one Product object. For example, LineItem_Object_{—}1 13 is related to Product_Object_{—}1 14, LineItem_Object_{—}2 12 is related to Product_Object_{—}2 15, and LineItem_Object_{—}3 11 is related to Product_Object_{—}2 15. As specified by the class diagram 3, each Product object 14, 15 contains a PRODUCT_ID attribute, a NAME attribute, and a PRICE attribute. The Purchase_Order_Object_{—}1 10 may be called the root of the object graph 8 because the Purchase_Order_Object_{—}1 10 (explicitly or implicitly) references all objects in the object graph 8 and is the entry point into the object graph 8.

It is common practice in object oriented technology to package objects for transport to another address space or for storage on a storage medium (such as a hard disk, removable medium, etc.). One of the reasons for transporting an object to another address space is to execute a remote method that takes the object as a parameter. Each object package includes the object of interest along with the other objects in the object graph containing the object of interest. The reason for including the other objects in the package is to preserve the relationship between the objects. The process of packaging an object graph typically involves saving the state of each object in the object graph as a sequence of bytes that can be rebuilt into a live object at a later time. There are generic solutions that package an entire object graph and recreate the objects at their target destination, e.g., another address space or storage medium, using their original classes. However, using the original classes may be inconvenient if there are objects at the target destination that contain similar classes and properties. This is a common occurrence when using remote objects, e.g., an object whose methods can be invoked on a remote machine, and proxy objects, e.g., local instance of a remote object, as proxy objects are inherently very similar to the remote objects.

### SUMMARY OF INVENTION

In general, in one aspect, the invention relates to a method for dynamically casting an object graph, comprising creating an internal representation using a root object of the object graph, instantiating a cast object graph using a casting rule and the internal representation, and populating the cast object graph.

In general, in one aspect, the invention relates to a method for dynamically casting an object graph, comprising retrieving a root object of the object graph using a variable usage specification, obtaining a class definition, wherein the class definition is used to create an internal representation, creating the internal representation using the root object of the object graph, instantiating a cast object graph using a casting rule and the internal representation, populating the cast object graph, and instantiating a cast object graph attribute using the casting rule and the internal representation.

In general, in one aspect, the invention relates to a distributed computer system, comprising a client, a server operatively connected to the client, a client-side transport packager located on the client, a server-side transport packager located on the server, means for creating an internal representation using a root object of the object graph, means for instantiating a cast object graph using a casting rule and the internal representation, and means for populating the cast object graph.

In general, in one aspect, the invention relates to a distributed computer system, comprising: a client, a server operatively connected to the client, a client-side transport packager located on the client, a server-side transport packager located on the server, means for retrieving a root object of the object graph using a variable usage specification, means for obtaining a class definition, wherein the class definition is used to create an internal representation, means for creating the internal representation using the root object of the object graph, means for instantiating a cast object graph using a casting rule and the internal representation, means for populating the cast object graph, and means for instantiating a cast object graph attribute using the casting rule and the internal representation.

In general, in one aspect, the invention relates to an apparatus for dynamically casting an object graph, comprising means for retrieving a root object of the object graph using a variable usage specification, means for obtaining a class definition, wherein the class definition is used to create an internal representation, means for creating the internal representation using the root object of the object graph, means for instantiating a cast object graph using a casting rule and the internal representation, means for populating the cast object graph, and means for instantiating a cast object graph attribute using the casting rule and the internal representation.

Other aspects and advantages of the invention will be apparent from the following description and the appended claims.

### BRIEF DESCRIPTION OF DRAWINGS

FIG. 1 illustrates a class diagram.

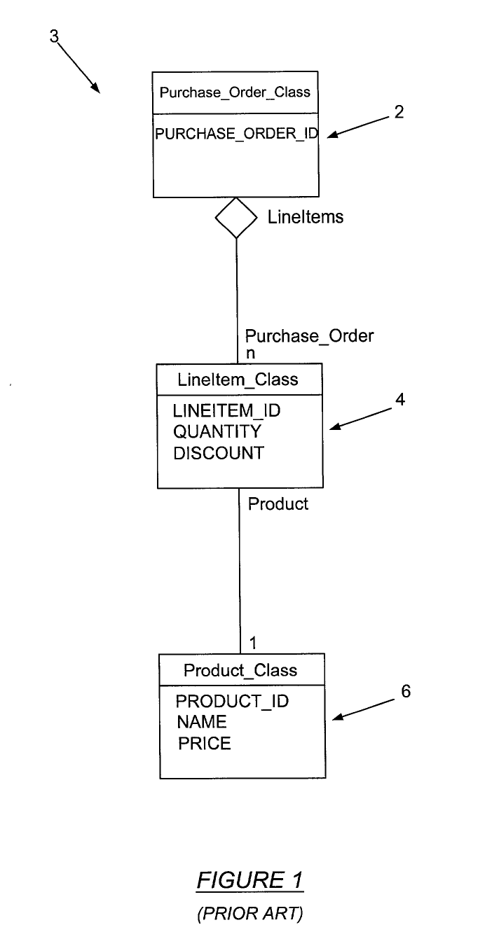

FIG. 2 illustrates an object graph created using the class diagram of FIG. 1.

FIG. 3 shows a transport packager according to one embodiment of the present invention.

FIG. 4 illustrates an cast object graph in accordance with one embodiment of the invention.

FIG. 5 shows one embodiment of a transport packager in a client-server environment.

FIG. 6 shows a flow chart in accordance with the embodiment of the invention shown in FIG. 5.

### DETAILED DESCRIPTION

Embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The present invention relates to an apparatus and method to dynamically cast objects within a distributed application. Further, the present invention relates to a method for using a variable usage specification to dynamically cast an object. Further, the present invention relates to a method for creating an internal representation of the cast object for transport or storage.

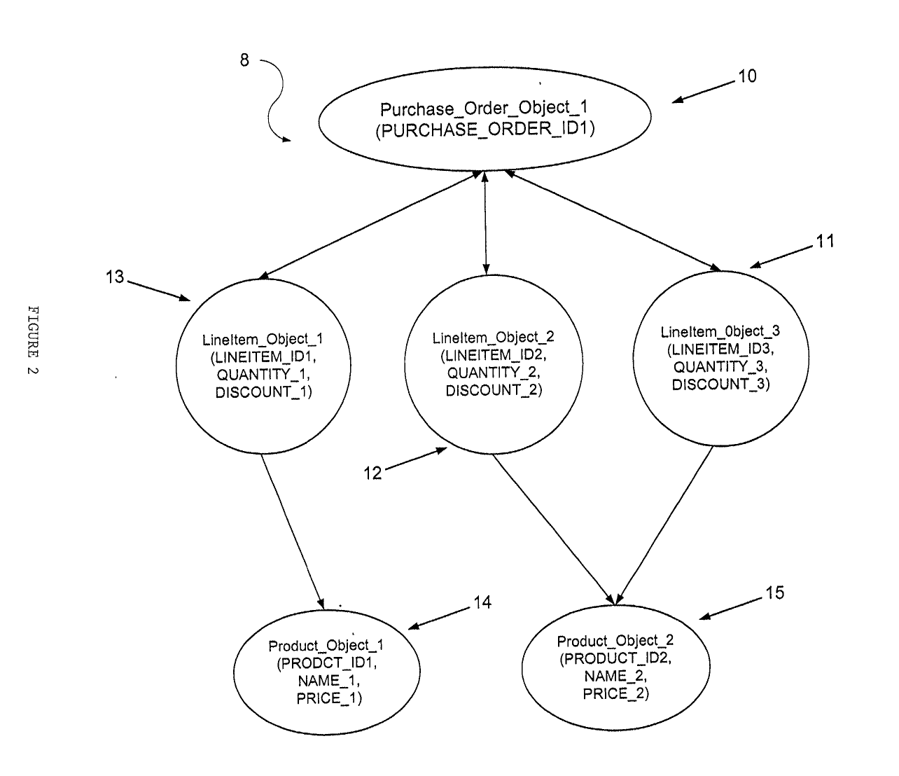

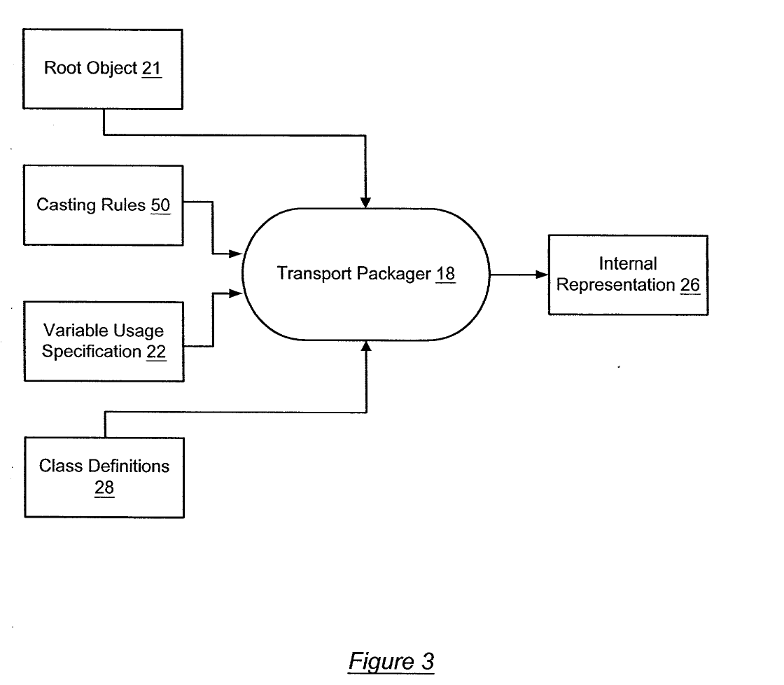

FIG. 3 shows a transport packager 18 according to an embodiment of the invention. The transport packager 18 takes a root object 21 (or reference to the root object), e.g., Purchase_Order_Object_{—}1 (10 in FIG. 2), a variable usage specification (VUS) 22, casting rules 50, and class definitions 28 as input and generates an internal representation 26 that includes only attributes and relationship information specified in the variable usage specification 22.

The root object 21 is an entry point in an object graph that references (implicitly or explicitly) all objects within the object graph. The VUS 22 specifies the objects and attributes to be transported to a client process (not shown) or stored on a storage medium (not shown). The VUS 22 also specifies which objects are required to be cast. The casting rules 50 define which objects within the object graph must be cast and what method to use to cast them.

The class definitions 28 are a template describing the fields (variables and constants) and methods that are grouped together to represent a particular object. The class definitions may be provided to the transport packager 18, or the transport packager 18 may derive this definition at runtime. Java™, for example, provides two mechanisms, called reflection and introspection, for discovering class definitions at runtime. These mechanisms can be used to obtain the names of the fields, methods, and constructors in the class. These mechanisms also allow objects to be created at runtime, even though the names of the classes from which the objects are created are not known until runtime. Typically, the classes from which the objects are instantiated have a default constructor that does not require arguments so that the object can be instantiated dynamically and its attributes populated in an arbitrary order. The attributes of the object are populated based on the VUS 22.

The internal representation 26 generated by the transport packager 18 contains all the information necessary to instantiate a cast object graph in the client process. Instantiation typically includes creating a new object graph if one is not currently present in the client process, or updating an existing object graph present in the client process. Further, the internal representation is typically in a format that can be readily transmitted over a network (not shown) or stored on a storage medium (not shown).

In one embodiment of the invention, an internal representation of the object graph is created using serialization. Serialization is the process of saving an object's state to a sequence of bytes, such that it may be rebuilt into a live object at some future time. The serialized file allows the data within the object graph to persist beyond the time the transport packager is active. Additionally, the serialized file may be copied and transferred to another system where it may be stored as a backup. The process of creating the serialized file is typically carried out using a Java™ Serialization Application Program Interface (API).

For illustration purposes, Table 1 shows an example of the VUS 22 based on the object graph 8 (shown in FIG. 2). It should be noted that there are a variety of ways of representing the VUS 22, and the format shown in Table 1 is not intended to limit the invention in any way. The VUS 22 references the portions of the object graph 8 (shown in FIG. 2) that are of interest. The references are made relative to the root of the object graph 8 (shown in FIG. 2), which is the Purchase_Order Object_{—}1 (10 in FIG. 2).

TABLE 1
Variable Usage Specification

Purchase_Order.PURCHASE_ORDER_ID
Purchase_Order.LineItems[1].LINEITEM_ID
Purchase_Order.LineItems[1].DISCOUNT
Purchase_Order.LineItems[2].QUANTITY
Purchase_Order.LineItems[3].DISCOUNT
Purchase_Order.LineItems[3].QUANTITY
Purchase_Order.LineItems[3].Product.PRODUCT_ID
Purchase_Order.LineItems[3].Product.PRICE

For illustration purposes, Table 2 shows an exemplary set of casting rules 50 based on the VUS. It should be noted that there are a variety of ways of representing casting rules 50, and the format shown in Table 2 is not intended to limit the invention in any way.

TABLE 2
Casting Rules

Casting_method.suffix ( [Purchase_Order_Object_1,
Line_Item_Object_1,
Line_Item_Object_2,
Line_Item_Object_3,
Product_Object_2] )

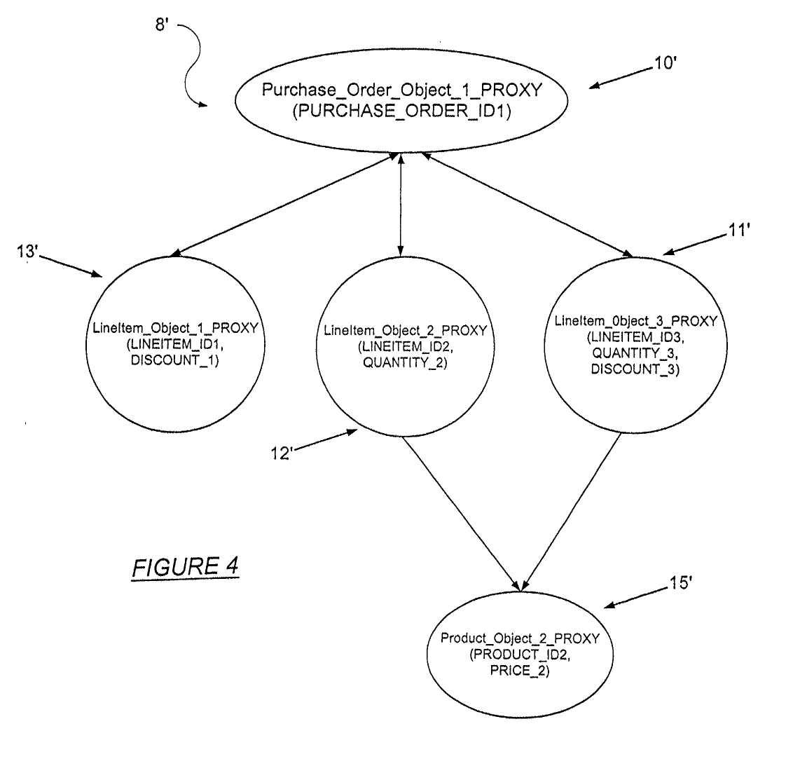

FIG. 4 illustrates an exemplary cast object graph in accordance with one embodiment of the invention that would result from applying the VUS in Table 1, and the casting rules in Table 2 to the object graph illustrated in FIG. 2. Each object within the cast object graph 8′ is appended with a “_PROXY” suffix. For example, Purchase_Order_Object_{—}1 is cast to Purchase_Order_Object_{—}1_PROXY.

The objects may be cast using a number of different methods. In one embodiment of the invention, the transport packager 18 dynamically casts the remote objects to proxy objects using a mapping method. The mapping method maps a specifically named class to another specifically named class, e.g., “Employee” is cast to “MyEmployeeBean.”

In another embodiment of the invention, the transport packager 18 dynamically casts the remote objects to the proxy objects using a suffix method. The suffix method adds a suffix to a class name for instances of a superclass, e.g., “Employee” is cast to “Employee_Proxy.”

In another embodiment of the invention, the transport packager 18 dynamically casts the remote object to the proxy object using a parser method. The parser method performs a search and replace to a class name for instances of a superclass, e.g., “EmployeeBean” is cast to “Employee_Proxy.”

In another embodiment of the invention, the programmer may use the interface provided by the transport packager 18. The interface of the transport packager 18 manages the introspection and recreation of objects if a particular application requires extensive control. Implementations of the interface can control how an object is introspected, recreated, and cast.

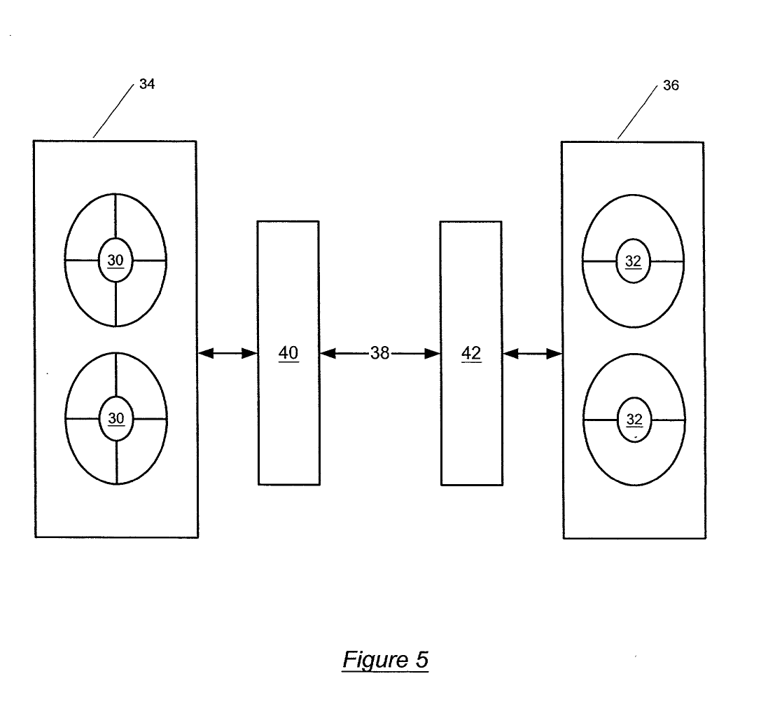

FIG. 5 shows one embodiment of a transport packager in a client-server environment. The environment includes client-side distributed objects 30 and server-side distributed objects 32 separated across a client 34 and a server 36, respectively. The client 34 and server 36 run on separate machines and communicate via a network link 38. Further, the client 34 includes a client-side transport packager 40, and the server 36 includes a server-side transport packager 42.

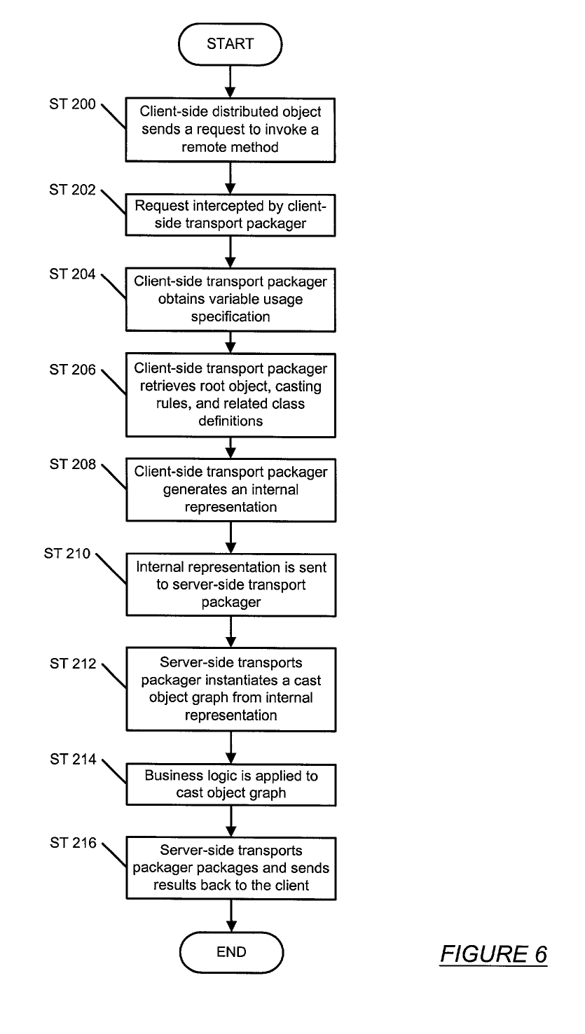

FIG. 6 shows a flow chart for one embodiment of the present invention operating in a distributed environment, as shown in FIG. 5. A client-side object 30 sends a request to invoke a remote method on a server 36 (Step 200). The request is intercepted by a client-side transport packager 40 (Step 202). The client-side transport packager 40 obtains a VUS from the client 34 (Step 204). The client-side transport packager 40, based on the VUS, retrieves a root object, casting rules, and related class definitions (Step 206). The client-side transport packager 40 generates an internal representation (not shown) using the UVS, casting rules, class definitions, and the root object (Step 208).

The internal representation is then sent to a server-side transport packager 42 (Step 210). The server-side transport packager 42 instantiates a cast object graph from the internal representation (Step 212). Business logic is applied to the cast object graph (Step 214), where business logic includes methods for manipulating the object graph and contents of the object graph. Results of applying business logic are packaged and sent back to the client 34 (Step 216).

Advantages of the invention may include one or more of the following. The dynamic casting enables instances of particular classes to be automatically converted into similar classes with similar members. This is particularly useful when transporting objects between a client and a server where the implementations are in fact completely different, but the objects share a common interface or simply share common members. The dynamic casting enables complex objects to be cast without defining explicit cast conversions in the class source code. The flexible nature of the dynamic casting provides programmers numerous options to implement dynamic casting of objects. Further, the invention allows individual tiers in a multi-tier system to be migrated separately. Further, the invention allows objects to be cast in a transparent fashion, i.e., the objects to be cast do not know about the casting rules and the objects do not need to be modified to work with the invention. Those skilled in the art can appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for dynamically casting an object graph, comprising:
creating an internal representation using a root object of the object graph;
instantiating a cast object graph using a casting rule and the internal representation; and
populating the cast object graph.

2. The method of claim 1, further comprising:
instantiating a cast object graph attribute using the casting rule and the internal representation.

3. The method of claim 1, further comprising:
retrieving the root object using a variable usage specification.

4. The method of claim 1, further comprising:
obtaining a class definition, wherein the class definition is used to create the internal representation.

5. The method of claim 4, wherein the class definition is generated at runtime by a transport packager.

6. The method of claim 1, wherein the casting rule comprises a casting method.

7. The method of claim 6, wherein the casting method implements a mapping method.

8. The method of claim 6, wherein the casting method implements a suffix method.

9. The method of claim 6, wherein the casting method implements a parser method.

10. The method of claim 1, wherein the internal representation is a serialized file.

11. A method for dynamically casting an object graph, comprising:
retrieving a root object of the object graph using a variable usage specification;
obtaining a class definition, wherein the class definition is used to create an internal representation;
creating the internal representation using the root object of the object graph;
instantiating a cast object graph using a casting rule and the internal representation;
populating the cast object graph; and
instantiating a cast object graph attribute using the casting rule and the internal representation.

12. A distributed computer system, comprising:
a client;
a server operatively connected to the client;
a client-side transport packager located on the client;
a server-side transport packager located on the server;
means for creating an internal representation using a root object of the object graph;
means for instantiating a cast object graph using a casting rule and the internal representation; and
means for populating the cast object graph.

13. The distributed computer system of claim 12, further comprising:
means for instantiating a cast object graph attribute using the casting rule and the internal representation.

14. The distributed computer system of claim 12, further comprising:
means for retrieving the root object using a variable usage specification.

15. The distributed computer system of claim 12, further comprising:
means for obtaining a class definition, wherein the class definition is used to create the internal representation.

16. The distributed computer system of claim 15, wherein the class definition is generated at runtime by a transport packager.

17. The distributed computer system of claim 12, wherein the casting rule comprises a casting method.

18. The distributed computer system of claim 17, wherein the casting method implements a mapping method.

19. The distributed computer system of claim 17, wherein the casting method implements a suffix method.

20. The distributed computer system of claim 17, wherein the casting method implements a parser method.

21. The distributed computer system of claim 12, wherein the internal representation is a serialized file.

22. A distributed computer system, comprising:
a client;
a server operatively connected to the client;
a client-side transport packager located on the client;
a server-side transport packager located on the server;
means for retrieving a root object of the object graph using a variable usage specification;
means for obtaining a class definition, wherein the class definition is used to create an internal representation
means for creating the internal representation using the root object of the object graph;
means for instantiating a cast object graph using a casting rule and the internal representation;
means for populating the cast object graph; and
means for instantiating a cast object graph attribute using the casting rule and the internal representation.

23. An apparatus for dynamically casting an object graph, comprising:
means for retrieving a root object of the object graph using a variable usage specification;
means for obtaining a class definition, wherein the class definition is used to create an internal representation;
means for creating the internal representation using the root object of the object graph;
means for instantiating a cast object graph using a casting rule and the internal representation;
means for populating the cast object graph; and
means for instantiating a cast object graph attribute using the casting rule and the internal representation.
